(19) United States
(12) Patent Application Publication
(10) Pub. No.: US 2016/0026963 A1
(43) Pub. Date: Jan. 28, 2016

(54) FUNCTIONING OF A COMPUTER SYSTEM THAT FACILITATES DISTRIBUTION OF WORK

(71) Applicant: ORACLE INTERNATIONAL CORPORATION, Redwood Shores, CA (US)

(72) Inventors: Ravi Ramesh Rathod, Sunnyvale, CA (US); Akshoy Upadhyay, Foster City, CA (US); Victor A. Saberi, San Mateo, CA (US); Vanita R. Rathod, Bangalore (IN); Adam Lawrence Heller, Milpitas, CA (US)

(73) Assignee: ORACLE INTERNATIONAL CORPORATION, REDWOOD SHORES, CA (US)

(21) Appl. No.: 14/533,744

(22) Filed: Nov. 5, 2014

Related U.S. Application Data
(60) Provisional application No. 62/028,269, filed on Jul. 23, 2014.

(51) Int. Cl. G06Q 10/06; G06Q 30/06

(52) U.S. Cl. CPC G06Q 10/063112; G06Q 30/0611

(57) ABSTRACT

A request is transmitted to a computer operated by an approver, to respond with approval or disapproval for an employee to work on a project, before a bid identifying that employee can be accepted. Requests for approval or disapproval are transmitted based on one or more employees identified in a bid, by looking up a database, to identify the approver of each employee. To facilitate the look up, each employee to be identified in a bid is required to have a profile in a set of profiles of employees in an organization. After responses of approval are received for employees identified in bids, those bids are transmitted to a computer operated by a project manager. Obtaining approval(s) before a bid can be accepted increases the likelihood of work being done in a timely manner, thus improving the functioning of a computer system that facilitates distribution of work.

### CROSS-REFERENCE TO PROVISIONAL APPLICATION

This patent application claims priority under 35 USC §119 from U.S. Provisional Application 62/028,269 entitled “FUNCTIONING OF A COMPUTER SYSTEM THAT FACILITATES DISTRIBUTION OF WORK” filed on Jul. 23, 2014 by Ravi R. Rathod, Akshoy Upadhyay, Victor A. Saberi, Vanita R. Rathod, and Adam L. Heller which is hereby incorporated by reference herein in its entirety.

### FIELD

This patent application relates to improvements in the functioning of a computer system that facilitates distribution of work.

### BACKGROUND

Computer systems that facilitate distribution of work are well known in the art. For example, a website www.elance.com acts as a virtual marketplace where employers post jobs. Freelancers bid on the jobs posted by employers. Employers can review bids as well as each bidder's star rating, which is earned based on delivery of high quality work and buyer satisfaction on past jobs. Thus a computer system which hosts this website facilitates distribution of work, from employers to freelancers.

One issue with such a prior art computer system is that at the time the work is being distributed, an employer does not know the workload of each bidder. Specifically, the inventors of the current patent application note that there appears to be no mechanism in such a prior art computer system, to prevent a bidder from bidding on and accepting too many jobs, become overcommitted, and fail to deliver quality work in a timely manner. In such a situation, the current inventors note that it would have been better for the employer to have picked a bidder with a lower workload even if their bid is higher, but the prior art computer system does not appear to provide visibility to the employer into each bidder's workload.

A webpage on the Internet, at libraryclips.blogsome.com believed to be published on Oct. 3, 2011 mentioned that a freelancer can work in-house within an organization as a contractor, and manage their own benefits plan and taxes. According to this article, freelancing within the organization has a social aspect, which enables people to connect to one another.

Hence, there appears to be a need for improvements in the functioning of a computer system that facilitates distribution of work, as described below.

### SUMMARY

Several described embodiments improve the functioning of a computer system that facilitates distribution of work, by use of one or more of the following: obtaining approval to bid prior to bidding, use of points to motivate employees, and ranking of employees specifically for a project (based on skills required in the project).

Some embodiments transmit a request for approval or disapproval of an employee to work on a project, before a bid for the project identifying that employee can be accepted. The request is transmitted to a computer operated by a person (“bidding approver”) who has authority to provide an approval for the employee to bid. In some embodiments, the bidding approver may be any person to whom the employee directly reports, such as a departmental manager, identified in a hierarchical chart of the organization. Some embodiments enable a bidding approver to delegate approval authority to a colleague of the employee, e.g. a person at a higher position than the employee in the organizational chart (such as a team leader), or to delegate approval authority any other colleague having knowledge of employee's workload. In several embodiments, the bidding approver is expressly identified in a database as having authority to provide approval of a specific employee to bid on projects, while other embodiments default to using each employee's departmental manager in the hierarchical chart in the database as the bidding approver.

Accordingly, one or more requests for approval or disapproval are transmitted for a bid, based on one or more employees identified in the bid, either by a computer from which the bid originates, or alternatively by a server that receives the bid, depending on the embodiment. In several embodiments, a set of computers originating bids or the server look up database (e.g. a hierarchical chart therein), to identify an employee's bidding approver (also called simply “approver”). Some embodiments require that each employee identified in a bid have a position in the hierarchical chart of the organization, so that the employee's approver can be identified by looking up the chart. To ensure bids are acceptable, some embodiments require that skills identified as being required in a specific project match skills identified in one or more profiles as being possessed by one or more employees included in a bid for that specific project.

After responses of approval are received from computers of bidding approvers of one or more employee(s) identified in a specific bid, that specific bid is transmitted to a computer operated by a project manager that created the project (identified in the specific bid). Obtaining approval(s) for employees to participate in a bid, before the bid can be accepted eliminates or minimizes the likelihood of an employee being unable to deliver work in a timely manner, which thereby improves the functioning of a computer system that facilitates distribution of work.

Certain embodiments use points that are convertible into currency and/or redeemable into benefits such as paid time off and/or flex spending, and/or gifts coupons, to motivate employees to work on projects, thereby to improve the functioning of a computer system that facilitates distribution of work. In several embodiments, a computer operated by an organizational head identified in a database (e.g. in a hierarchical chart) as being higher than a project manager transmits to the computer operated by the project manager, a number of points (“first number” or “budget points”) that are assignable by the project manager to one or more projects. Then, the computer operated by the project manager transmits to the server, another number of points (“second number”, or “project points”) as being assigned to the specific project, the second number being less than or equal to the first number. During the bidding process, each computer in the set of computers transmits to the server, in association with each bid, yet another number of points (“third number” or “bid points”), which are selected to be less than or equal to the second number (or project points). The server then transmits to the computer operated by the project manager, one or more third number or bid points in association with one or more bids, prior to receipt of a decision accepting a specific bid.

Subsequently, when the server receives from the computer operated by the project manager, an indication of acceptance of work product of a specific project, the server transmits one or more fourth numbers of points (“earned points”) to one or more computers of one or more employees identified in the bid and transmits one or more fifth numbers of points (“management points”) to one or more computers of approvers of the bidding employee(s) and/or to one or more computers of departmental managers to whom the bidding employee(s) directly report. Management points are allocated to bidding approvers in some embodiments, or alternatively allocated to departmental managers who may or may not be bidding approvers in other embodiments, or shared as per a fixed ratio or formula between bidding approvers and departmental managers in still other embodiments. A total of the fourth number(s) or earned points, and the fifth number(s) or management points that are being transmitted at this stage, is equal to the third number or bid points associated with the specific bid. Each fifth number or management points is determined by a fixed formula or ratio based on at least a fourth number or earned points (e.g. management points may be a predetermined fraction of earned points being awarded, such as one-third or ⅓).

In several embodiments, a server of the type described above also enables employees to earn points in exchange for work product not specified in any project, as follows. Specifically, the server receives from the computers of employees, work products created by the employees, and points associated thereto. Subsequently, on receiving a request for a specific work product (e.g. from a computer operated by a project manager), the server transmits the requested work product to the computer from which the request is received. Then, the server transmits points associated with the work product, to one or more computer(s) of one or more employee(s) that created the work product, and to computers of one or more manager(s) of the one or more employee(s), e.g. as per the above-described fixed formula. The server subtracts the points associated with the work product from a number of points of the person that received the specific work product. For example, depending on the role of the person that received the work product, the server reduces budget points if the person is a project manager, reduces earned points if the person is an employee, or reduces management points if the person is a manager, by the points associated with the work product.

Several embodiments rank one or more employee(s) identified in a bid for a specific project, based on depth of competence of the one or more employee(s) in one or more skills necessary to perform the specific project, when the bid is transmitted to a computer operated by a project manager that created the specific project (identified in the bid). Ranking employees that bid on a specific project, in descending order based on the depth of their competence, in one or more skills which are required by the specific project, eliminates or minimizes the likelihood of a bid by the employee having superficial competence in the skills necessary to perform a project being accepted, relative to another bid by another employee of deeper competence, thereby improving the functioning of a computer system that facilitates distribution of work. In some embodiments, the depth of competence in a skill is determined by logic based on the level of one or more formal credentials, such as degree of education (e.g. B.S., M.S., or PhD), and additionally based on points earned on projects and/or points earned by exchanging work product unrelated to projects. Specifically, earned points that are allocated to an employee for their work product (e.g. on a specific project or not specified in any project) as described above, are subdivided by a person that receives the work product, across one or more skills of the employee(s), e.g. in a distribution that is transmitted to the server by a computer operated by a project manager with an indication of acceptance of the work product in a project. Therefore, earned points improve the ranking of specific employee(s) in specific skills, which in turn improves the likelihood of acceptance of new bids of the specific employee(s) on new projects requiring those specific skills, in a virtuous circle that results in synergy.

It is to be understood that several other aspects of the described embodiments will become readily apparent to those skilled in the art from the description herein, wherein it is shown and described various aspects by way of illustration. The drawings and detailed description below are to be regarded as illustrative in nature and not as restrictive.

### BRIEF DESCRIPTION OF THE DRAWINGS

FIG. 1A shows, in a data flow diagram, a server 200 that facilitates distribution of work, by transmitting a request 132A to a computer 130A operated by an approver (such as a departmental manager or team leader) of an employee identified in a bid, before the bid can be accepted by a project manager, in some illustrative embodiments.

FIGS. 1B and 1C show, in alternative data flow diagrams that are similar to FIG. 1A, computer 120A operated by an employee transmitting request 132A to computer 130A operated by the approver, before server 200 submits a bid identifying the employee to computer 110 of a project manager, in some illustrative embodiments.

FIG. 2 illustrates, in a flow chart, acts performed by an auctionplace component 210A of a work distributor 210 in one or more computers 200 by use of one or more processors programmed with a sequence of instructions of software stored in one or more memories, to implement an improved work distributor, in exemplary embodiments in accordance with the invention.

FIG. 3 illustrates, in another flow chart, acts performed by a marketplace component 210I of work distributor 210 in computer(s) 200 of FIG. 2 to facilitate exchange of work product between employees and product managers, in certain embodiments.

FIGS. 4A and 4B illustrate, in flow charts, acts performed by a points component 210N of work distributor 210 in computer(s) 200 of FIG. 2 to facilitate distribution and earning of points by project managers and employees respectively, in certain embodiments.

FIG. 5 illustrates, in a flow chart, acts performed by a project-specific ranking component 210Z of work distributor 210 in the computer(s) 200 of FIG. 2 to facilitate ranking of employees for each specific project, in certain embodiments.

FIGS. 6A-6D illustrate screens generated by one or more computers 200 in performing acts of the type described herein. FIG. 6E illustrates in a screen, receipt of work product by computer 120A, via user input from employee 121A in certain embodiments.

FIG. 7A illustrates, in a block diagram, hardware portions of one or more computers 200 programmed with software portions of the type illustrated in FIG. 7B or 7C to perform one or more acts illustrated in FIGS. 2, 3, 4A, 4B, and 5 in some embodiments.

FIGS. 7B and 7C illustrate, in block diagrams of alternative embodiments, one or more computers 200 of the type shown in FIG. 7A programmed with software to perform one or more acts illustrated in FIGS. 2, 3, 4A, 4B, and 5 with an employee ranking component that is either internal to or external to work distributor 210.

### DETAILED DESCRIPTION

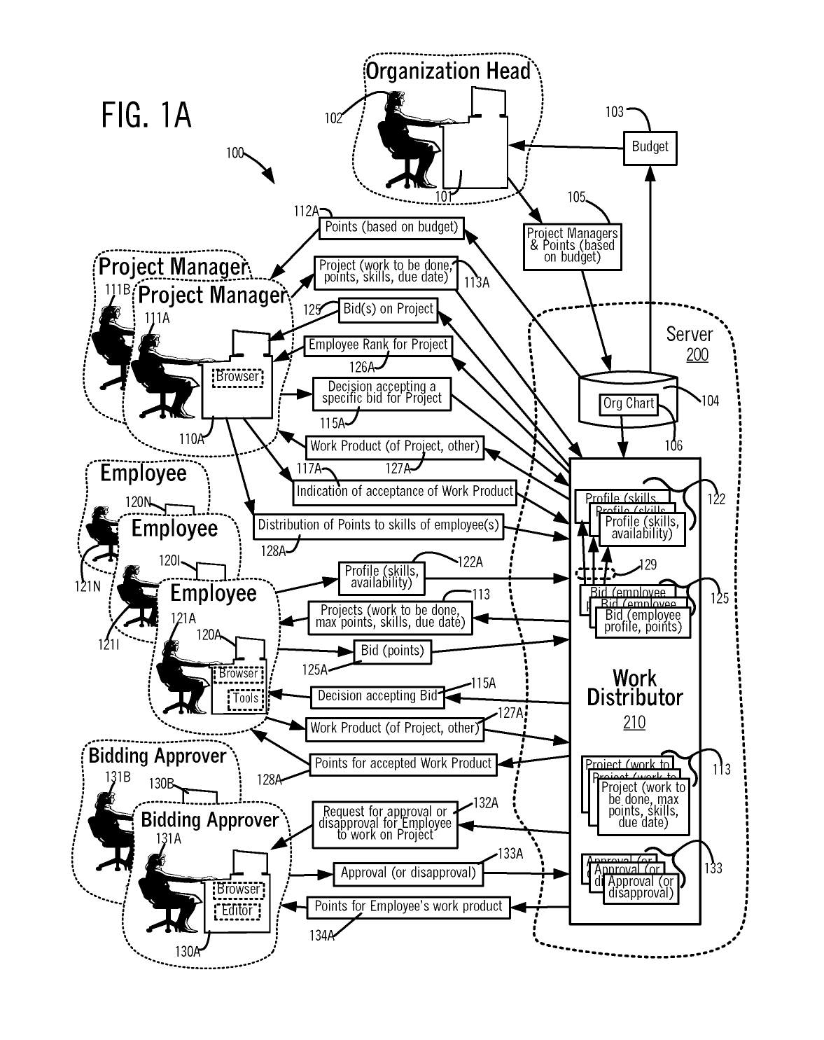

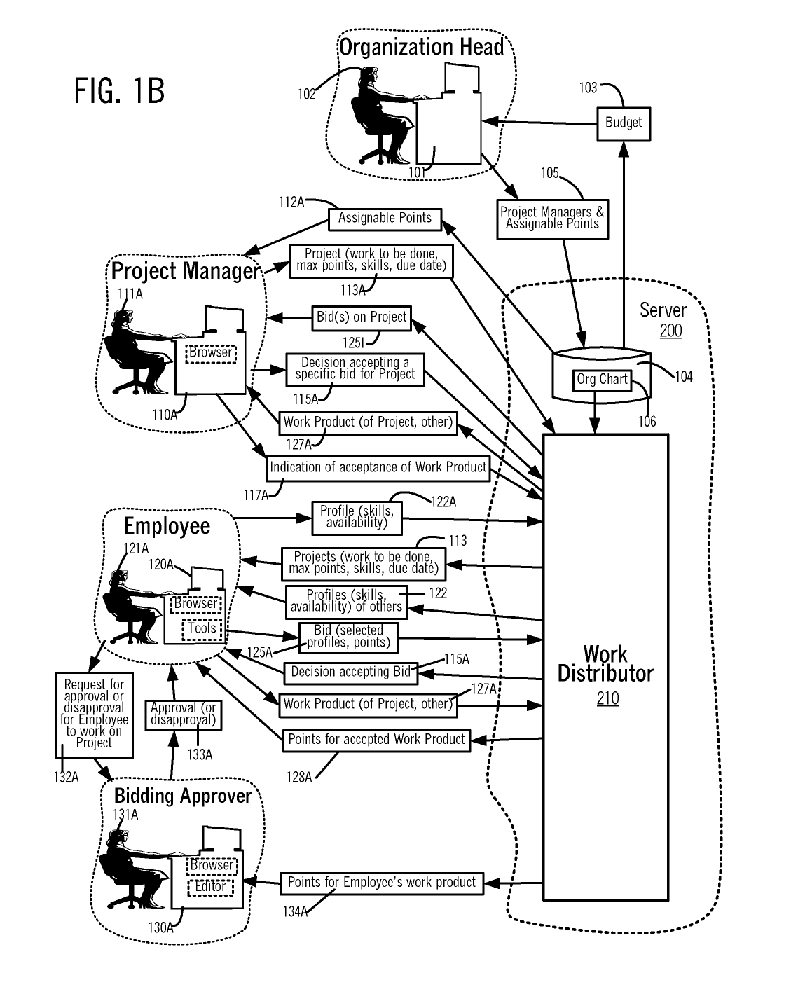

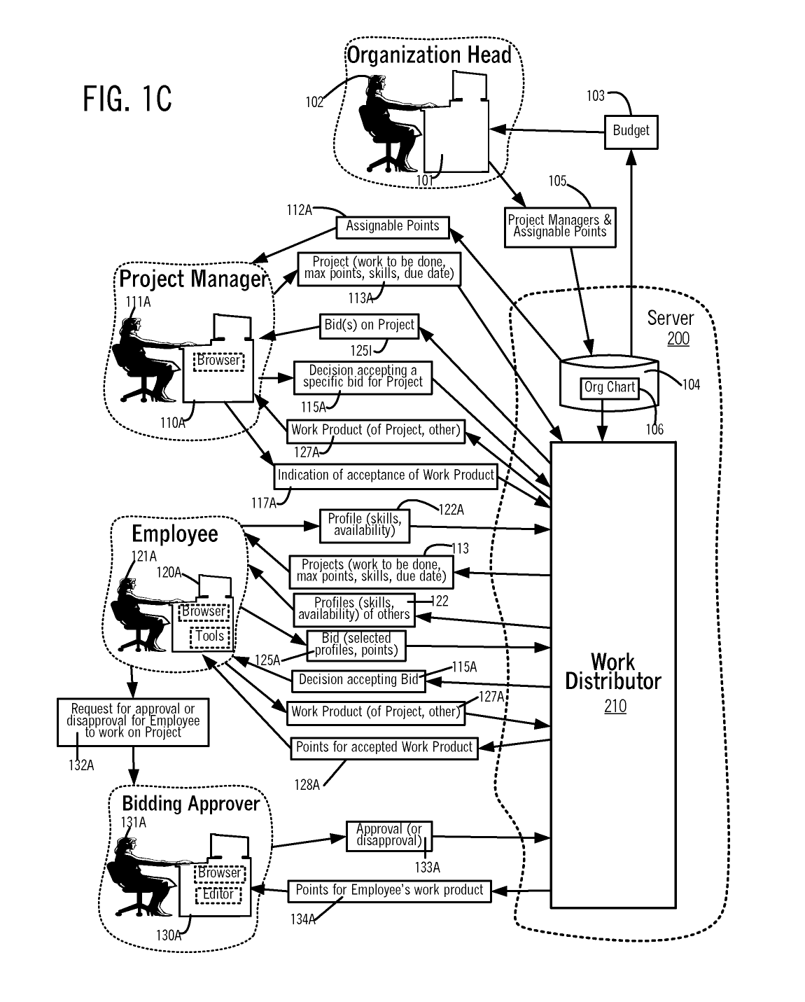

Several embodiments of a computer system 100 use points to compensate employees for working on projects. In several such embodiments, a computer 101 operated by an organizational head 102 (FIG. 1A), who is identified in a hierarchical chart 106 of an organization as being higher than project managers 111A, 111B transmits to a specific computer 110A operated by a specific project manager 111A, a number of points (“first number” or “budget points”) that are assignable by that project manager 111A. A specific manner by which organizational head 102 comes up with the number of points that are assignable is different in different embodiments.

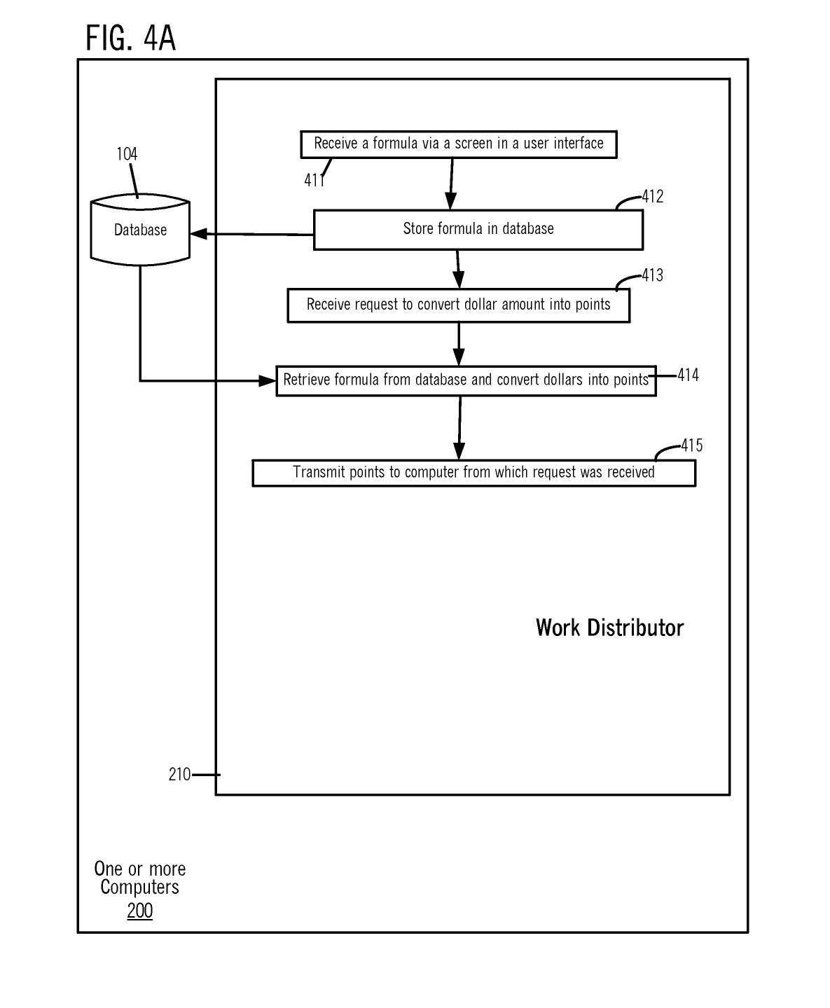

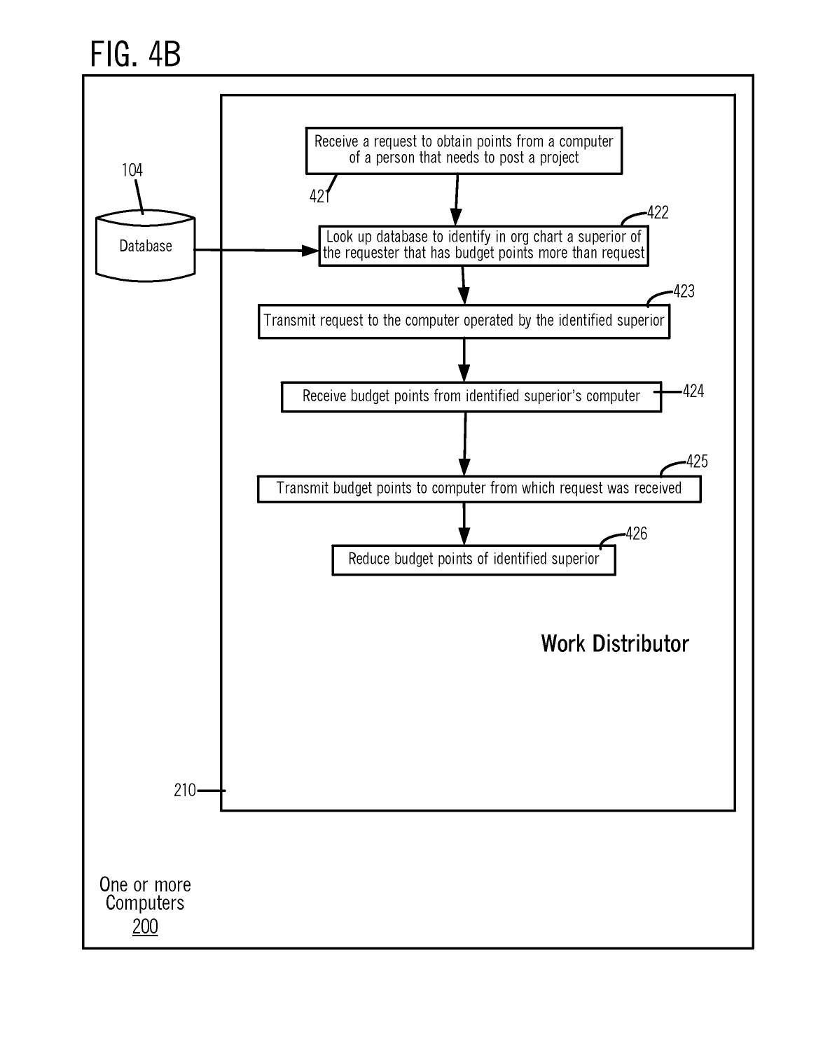

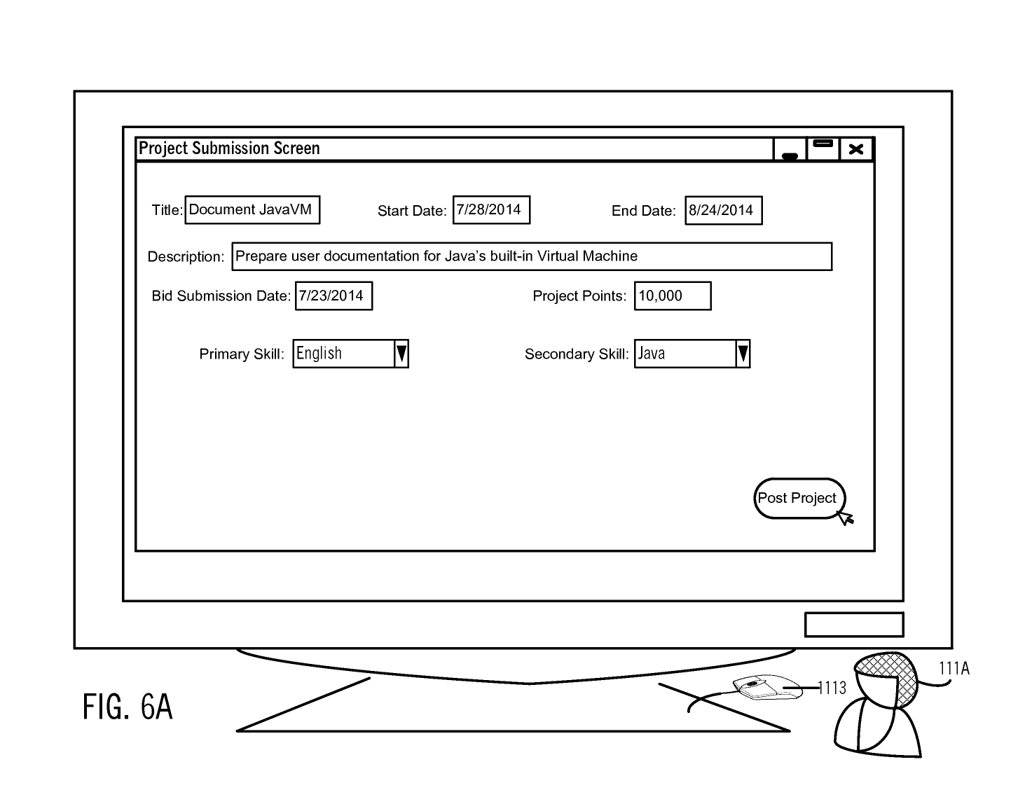

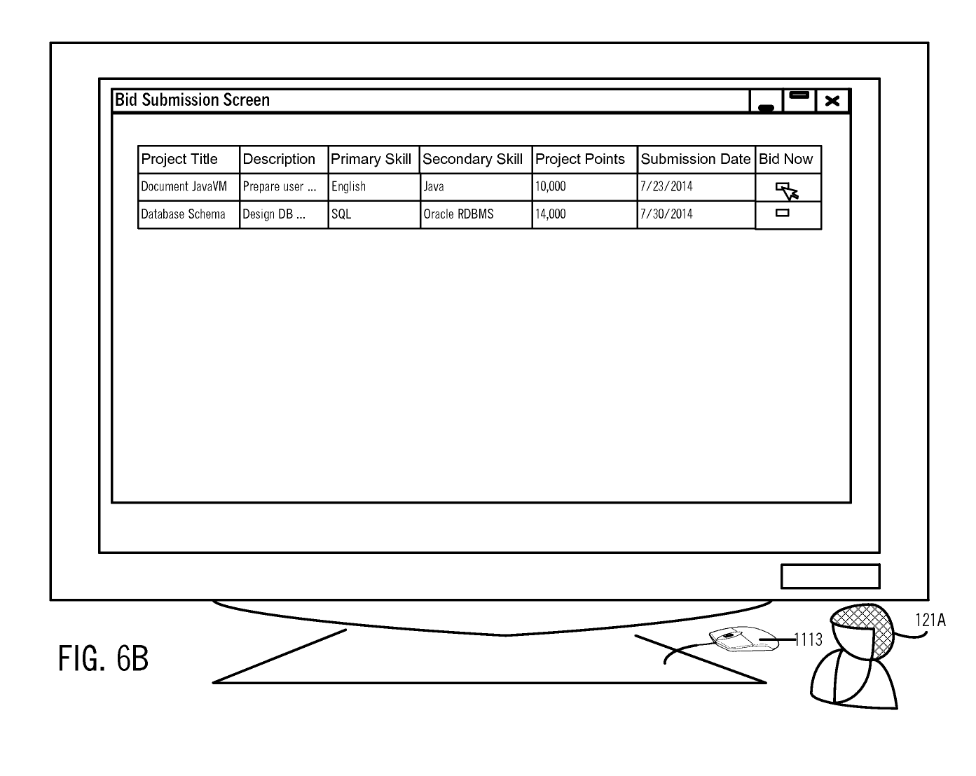

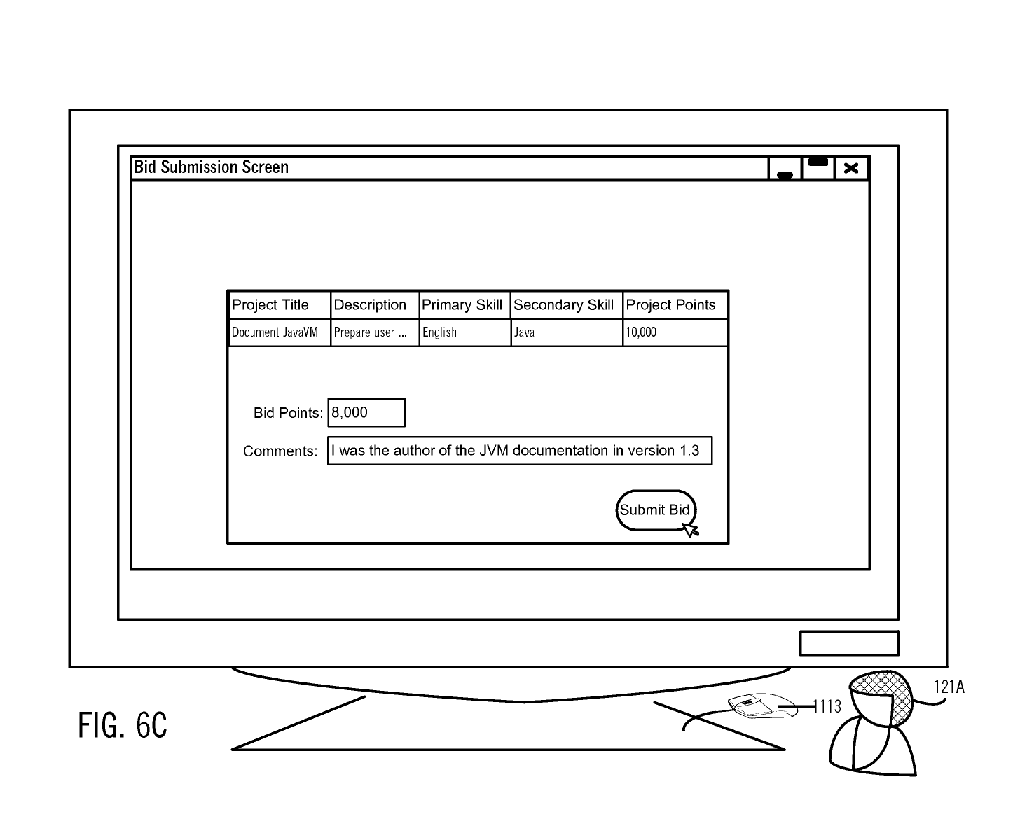

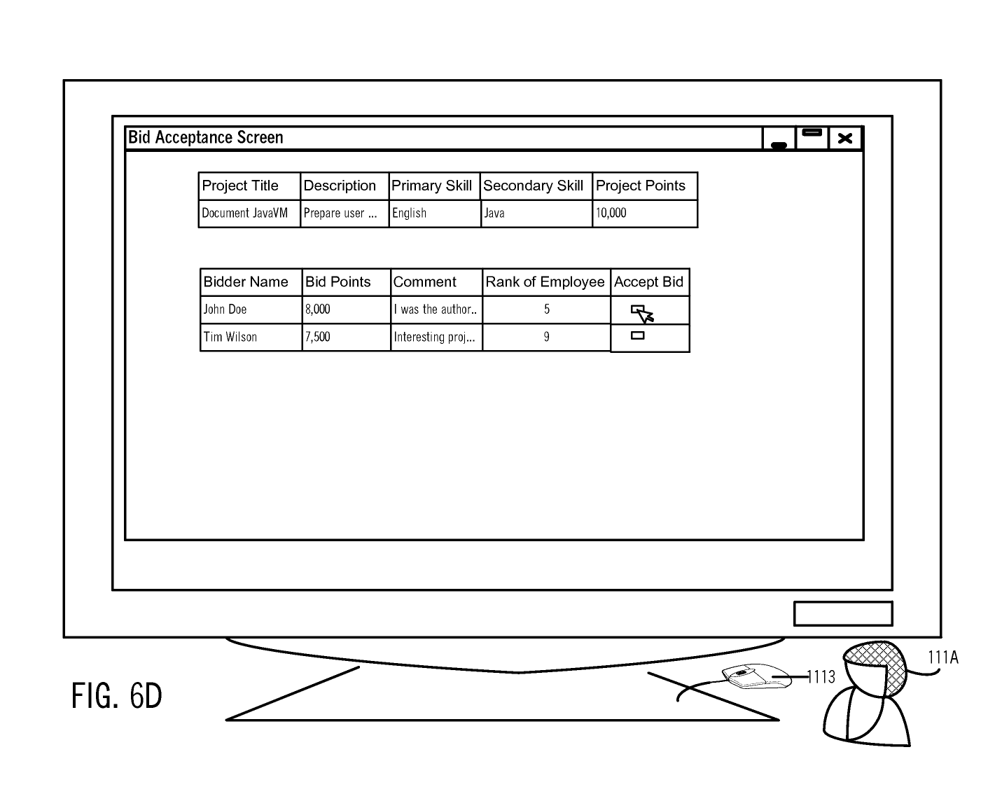

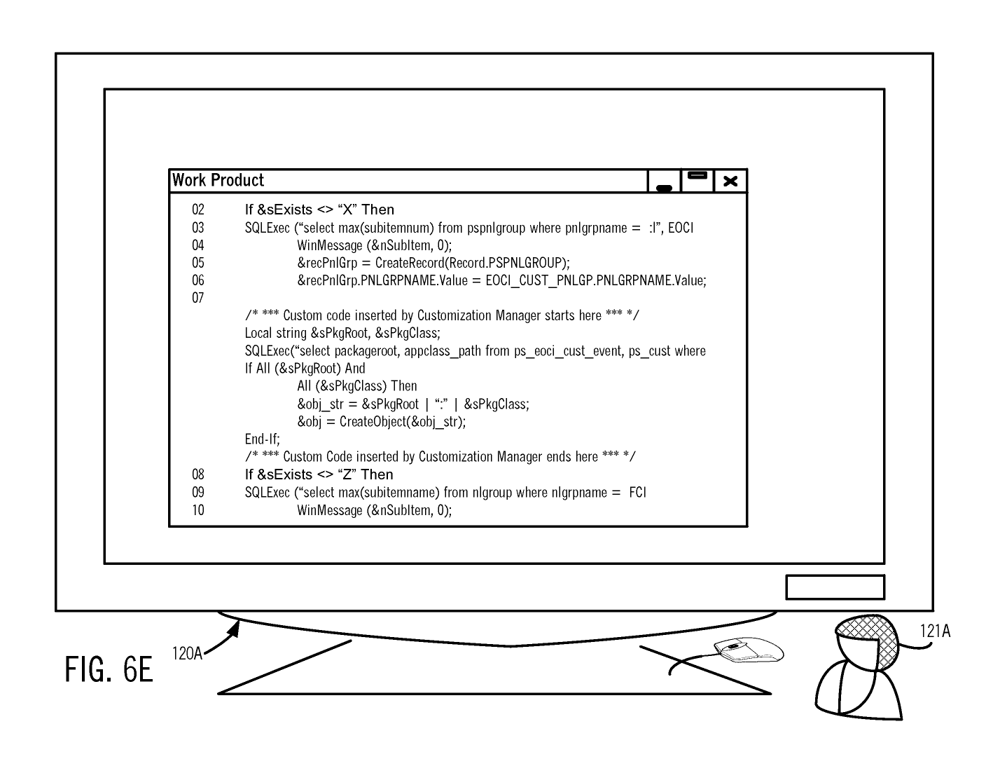

In certain embodiments, organizational head 102 reviews a budget 103 and manually determines a dollar amount to be converted into a total number of points, e.g. as a percentage of the budget to pay for projects by project managers 111A and 111B. The points are obtained based from the dollar amount by use of a conversion formula, as illustrated in FIG. 4A. Thereafter, organizational head 102 distributes the total number of points by subdivision among various project managers 111A and 111B, in a distribution 105 that is transmitted by computer 101 to server computer 200. Thus, server computer 200 transmits to computer 110A operated by project manager 111A, the budget points 112A as being assignable by project manager 111A to one or more projects, which the project manager 111A may specify. Thereafter, project manager 111A specifies a project, by providing user input through a screen of a graphical user interface (GUI) (e.g. as shown in FIG. 6A) including one or more of the following: a description of work to be done, points that can be earned on completion of the project, skills required to complete the project, and a due date. Accordingly, computer 110A of project manager 111A transmits a project 113A to server computer 200, including a second number of points (“project points”) assigned to the specific project 113A, the project points being less than or equal to the budget points assignable by that project manager 111A.

To earn points of the type described above, employees 121A . . . 121I . . . 121N of an organization need to register with server computer 200, e.g. by submitting individual profiles 122 to server computer 200. For example, a computer 120A transmits to server computer 200, a profile 122A of an employee 121A, which may include skills possessed by employee 121A, availability of employee 121A, formal credentials of employee 121A, identification of previous projects etc. One or more of the just-described profiles 122 may be included in bids 125 to perform projects 113 which are posted by project managers 111A, 111B as described above. For example, computer 120A of employee 121A receives a listing of one or more projects 113 (e.g. as shown in FIG. 6B). Employee 121A may create a bid, e.g. by clicking in any row of the right-most column in FIG. 6B, followed by providing user input on the number of bid points (e.g. as shown in FIG. 6C, including an optional comment to the project manager). Computer 120A of employee 121A submits (e.g. in response to employee 121A clicking on the “Submit Bid” button in FIG. 6C) a bid 125A to server computer 200. Thus, computer 120A transmits to server 200, in association with bid 125A for the specific project 113A, a third number of points (“bid points”), which are selected by employee 121A to be less than or equal to the project points assigned to the specific project 113A. In this manner, server 200 receives one or more bids 125 on a specific project 113A.

After receipt of a bid 125A, several embodiments of a server 200 improves the functioning of a computer system 100 that facilitates distribution of work, by transmitting a request 132A to a computer 130A operated by an approver 131A, to respond with approval or disapproval for an employee 121A (whose approval authority is with approver 131A) to work on the specific project 113A (for which bid 125A has been made). Thus, request 132A is transmitted before the specific bid 125A identifying that employee 121A is transmitted to computer 110A of project manager 111A, i.e. before bid 125A can be accepted. One or more requests 132A for approval or disapproval are transmitted by server computer 200 for a bid 125A, based on one or more employees 121A . . . 121I . . . 121N identified in the bid 125A. Note that although it is server computer 200 that transmits request(s) 132A in some embodiments, in alternative embodiments such requests 132A are transmitted by a computer 120A from which bid 125A originates, as illustrated in FIGS. 1B and 1C.

In several embodiments, either a set of computers 120A . . . 120I that originate bids 125 or alternatively server computer 200 look up a database 104 (e.g. a hierarchical chart 106 of the organization), to identify an approver for each employee 120I identified in bids 125. To facilitate the look up, some embodiments require that an employee 120I identified in a bid 125A have a profile 122I in a set of profiles 122 (see links 129 in FIG. 1A) of employees in an organization. Depending on the embodiment, bid 125I typically identifies employee 120I that submits bid 125I and may optionally identify a team of one or more other employees 120A . . . 120J . . . 120N as providing support to employee 120I. To ensure bids 125 are acceptable, some embodiments require that all skills identified as being required in a specific project 113A (e.g. primary skill English and secondary skill Java) match the skills that are identified in one or more profiles 122I (e.g. English and Java) as being possessed by employees 120I identified in each bid 125I.

Requests for approval or disapproval are received and displayed by computers 130A, 130B of approvers 131A, 131B (any person identified as having approval authority, e.g. departmental managers) of employees 121I . . . 121J identified in a bid 125I, and responses received via user input are then transmitted by computers 130A, 130B either to server computer 200 as illustrated in FIGS. 1A and 1C or to the computer 120A from which bid 125A originated (and which sent the request). When one or more responses 133 from one or more computers 130A, 130B for participation by one or more employees 121I . . . 121J in a bid 125I is/are approvals, that particular bid 125I is transmitted to computer 110A operated by project manager 111A that created the project 113A identified in bid 1251.

Thus, multiple bids 125 for a project 113A, after receipt of approval to bid of employees identified therein, are transmitted by server computer 200 to computer 110A of project manager 111A. Thus computer 110A displays multiple bids (e.g. two bids as illustrated by two rows shown in FIG. 6D) to project manager 111A. In some embodiments, each bid identifies a rank of the employee submitting the bid (“bidder”) for the specific project, as illustrated in FIG. 6D. Obtaining approval(s) 133 from approver(s) 131A, 131B as described above, before a bid 125I can be accepted, eliminates or minimizes the likelihood of an approved employee 121I being unable to deliver work in a timely manner, and in this manner improves the functioning of a computer system 100 that facilitates distribution of work in an organization.

In some embodiments, for each bid 125I (including bid points) that is transmitted by server computer 200 to computer 110A, server computer 200 also transmits one or more ranks of one or more employees 121I . . . 121J identified in the bid 125I, indicating depth of competence of the bidding employee(s) 121I . . . 121J in one or more skills necessary to perform the specific project 113A. The just-described rank of each employee 121I is specific to the project 113A, and so the rank of the same employee 121I changes for different projects, depending on the skills required, and depending on the depth of competence of employee 121I in the skills

Project manager 111A views bids 125 and ranks of bidding employees for a specific project 113A followed by indicating a decision to accept one specific bid 125A for the specific project 113A, selected from among the multiple bids 125A. Accordingly, computer 110A of project manager 111A transmits to server computer 200 a decision 115A, which is thereafter transmitted by server computer 200 to one or more computers 120A . . . 120I . . . 120N.

Employees 121I . . . 121J who are identified in the specific bid 125A which is accepted then work on project 113A, generating work product 127A which is submitted to computer 110A of project manager 111A either directly or via server 200. Project manager 111A views work product 127A, followed by providing an indication 117A of acceptance of the work product 127A for the specific project 113A. Accordingly, computer 110A of project manager 111A transmits indication 117A of acceptance of work product of a specific project 113A to server computer 200.

When server computer 200 receives from computer 110A operated by project manager 111A, indication 117A, the server computer 200 transmits fourth numbers of points to the computers 120I . . . 120J of the specific employees 121I . . . 121J identified in the accepted bid 125I. In addition, server computer 200 of some embodiments also transmits fifth numbers of points to computers 130A, 130B of the employees' departmental managers 131A, 131B. A total of the fourth numbers of points and the fifth numbers of points is equal to the third number of points associated with the specific bid 125I, and each fifth number is a fixed percentage of a fourth number.

In some embodiments, the fourth numbers of points allocated to one or more employees 121I . . . 121J are subdivided on a skill-by-skill basis, based on a distribution 128A that is optionally transmitted for ranking purposes, with acceptance indication 117A to server computer 200 by computer 110A operated by the project manager 111A. In alternative embodiments, no distribution is transmitted to server computer 200 by computer 110A with the acceptance indication 117A, and instead the distribution is predetermined as a fixed percentage, e.g. 75% of the fourth points are allocated to a skill (e.g. English) identified as being primary, and 25% of the fourth points are allocated to another skill (e.g. Java) identified as being secondary, both skills required in the project (e.g. see FIG. 6A).

In several embodiments, a server 200 of the type described above also enables employees 121A . . . 121I . . . 121N to earn points in exchange for work product not specified in a project, as follows. Specifically, the server 200 receives from the computers 120A . . . 120I . . . 120N of employees 121A . . . 121I . . . 121N, work products created by the employees 121A . . . 121I . . . 121N, and points associated thereto. Subsequently, on receiving a request for a specific work product, e.g. from a computer 110A operated by a project manager 111A, the server 200 transmits the requested work product (to the requesting computer). Then, the server 200 transmits points associated with the work product, to computers 120A . . . 120I . . . 120N of employees 121A . . . 121I . . . 121N that created the work product and to computers 130A, 130B of departmental managers 131A, 131B of the employees 121A . . . 121I . . . 121N. Finally, server 200 reduces the points associated with the work product from the number of points assignable by the project manager 111A (“first number”).

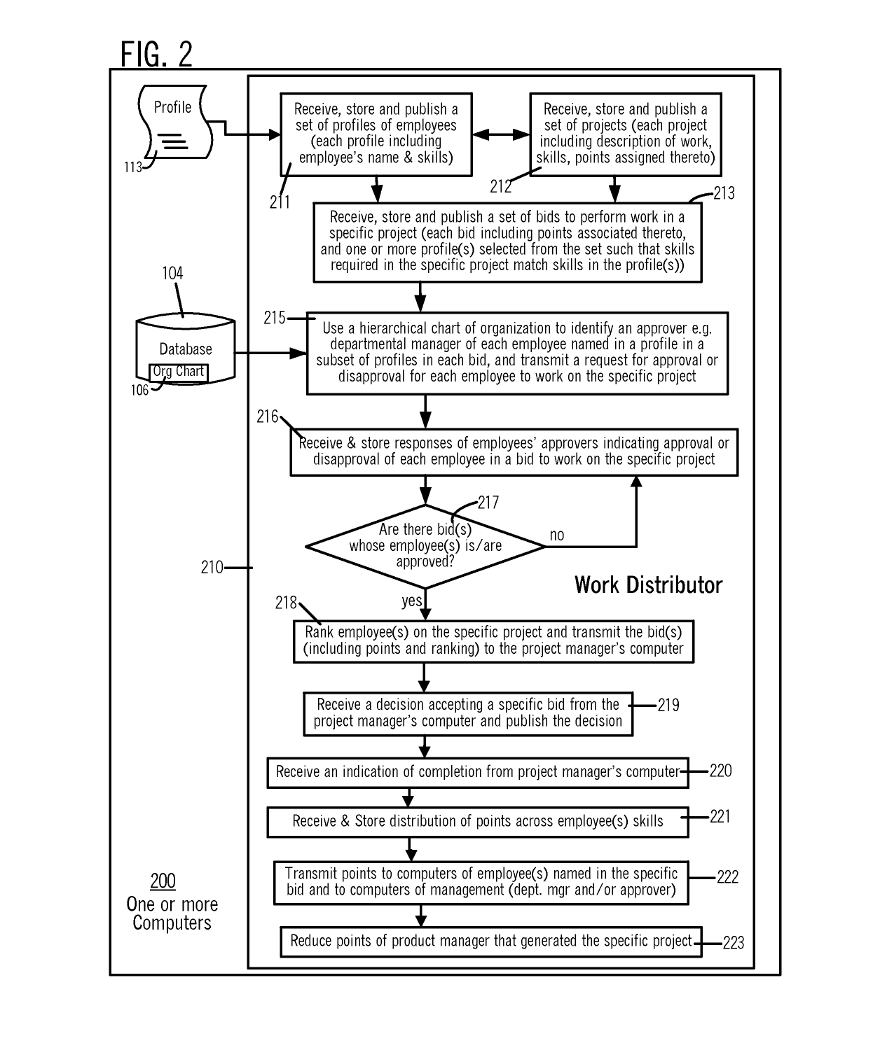

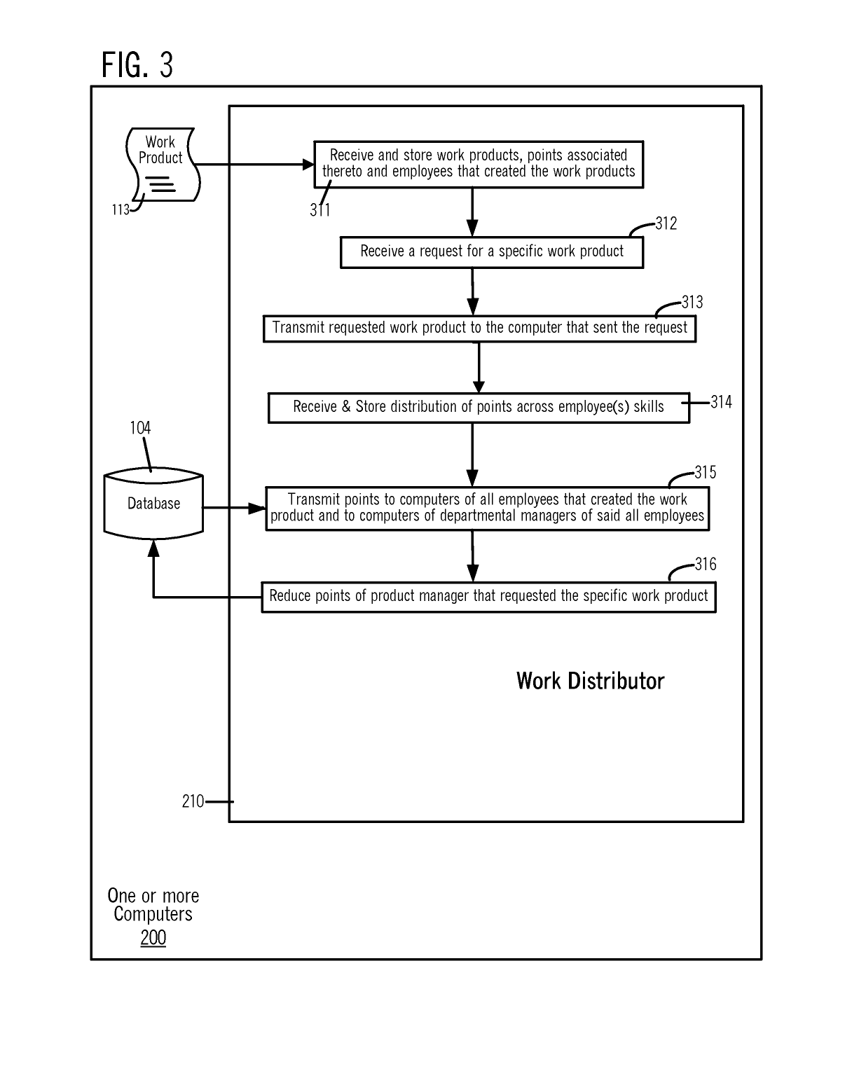

The above-described operations of server computer 200 of some embodiments are performed by a work distributor 210 which is programmed to perform acts 211-222 of a method illustrated in FIG. 2 and/or acts 311-315 of another method illustrated in FIG. 3, as follows. Work distributor 210 is programmed as per act 211 (FIG. 2) to receive, store and publish a set of profiles of employees (each profile including employee's name & skills) In act 211, each profile of an employee is stored in database 104, e.g. via a relational database management system (RDBMS), such as Oracle Database 11gR2, and the stored profiles are thereafter published e.g. by creation of a webpage for each profile and transmission of the webpage to a user (e.g. computers 110A, 120A . . . 120N or 130A . . . 130B). Moreover, work distributor 210 is programmed as per act 212, to receive, store and publish a set of projects (each project including description of work, skills, points assigned thereto). After one or more profiles are received in act 211, and after one or more projects are received in act 212, work distributor 210 performs an act 213 to receive, store and publish a set of one or more bids to perform work on a specific project (each project including description of work, skills, points assigned thereto).

After receipt of a bid in act 213, in an act 215, work distributor 210 of server 200 uses a database 104 to identify an approver (e.g. hierarchical chart 106 of the organization to identify a departmental manager) of one or more employee(s) named in one or more profile(s) identified in each bid, and transmits a request for approval or disapproval of the employee(s) to bid on the specific project. Hierarchical chart 106 may be implemented, for example, as a table in database 104, with at least two columns as follows: employee, approver. Then, in an act 216, work distributor 210 receives and stores responses of approvers, indicating approval or disapproval of each employee to bid on the specific project. Subsequently, in an act 217 that is performed periodically (or that may be event driven in alternative embodiments), work distributor 210 checks if there are any bids (“approved bids”) whose employees are approved to bid by their approvers, and if the answer is no, returns to act 216 (described above). If the answer is yes in act 217, work distributor 210 performs an act 218, to rank one or more employees having the skills specified in a specific project, and then transmits the approved bids (including the third number of points) and rank(s) of one or more employees identified in the approved bids, to the computer of the project manager. Act 218 is typically performed multiple times for a specific project, e.g. as and when bids are approved, i.e. bidding employees approved by respective approvers. In this manner, multiple bids 125A for a project 113A, after receipt of approvals of employees identified therein, are transmitted by server computer 200 to computer 110A of the project manager 111A that generated project 113A.

Subsequently, in an act 219, work distributor 210 of server 200 receives a decision 115A accepting a specific bid, from computer 110A of the project manager 111A that generated project 113A, and publishes the decision to one or more computers 120A . . . 120I . . . 120N. Thereafter, in an act 219, work distributor 210 receives an indication 117A of completion from computer 110A of the project manager 111A that generated project 113A. In certain embodiments, in an optional act 221, work distributor 210 also receives, for use as a value of a parameter in ranking, a skill-by-skill distribution 128A of earned points, from computer 110A of the project manager 111A that generated project 113A. In response to the indication 117A, in an act 222, work distributor 210 transmit fourth points to computers of one or more employees named in the specific bid and fifth points to computers of approvers and/or departmental managers of the named employees, as described above in reference to FIG. 1A. Thereafter, in an act 223, work distributor 210 reduces the assignable points of the project manager 111A that generated project 113A, by subtracting therefrom the third points which were transmitted in act 221 (as the sum of fourth points and fifth points).

Work distributor 210 of server 200 is programmed as per act 311 (FIG. 3) to receive and store work products of employees and associated thereto a number of points for which the work products are to be exchanged. Additionally, in act 311, work distributor 210 of some embodiments receives and publishes a description of each work product. Thereafter, work distributor 210 receives in act 312, a request for a specific work product followed by act 313 of transmitting the requested work product to the computer that sent the request (e.g. computer 110A of the project manager 111A). In addition, in some embodiments, in an optional act 314, work distributor 210 also receives a skill-by-skill distribution 128A of earned points for use in ranking, from the computer that received the requested work product (e.g. computer 110A of the project manager 111A). Then, in act 315, work distributor 210 transmits points to computers of all employees that created the work product, and optionally to computers of departmental managers of said all employees, e.g. as noted above. Thereafter, in an act 316, work distributor 210 reduces the points of whoever requested the work product (e.g. project manager 111A), by the number of points which were transmitted in act 314.

Work distributor 210 of server 200 is programmed as per act 411 (FIG. 4A) to prepare and transmit a screen in a user interface to a computer, e.g. computer 101 of an organizational head 102, and to receive via the screen (from computer 101) user input on a specific formula to be used to convert dollars into points and vice versa. For example, the formula may be 10×, whereby each dollar is convertible into 10 points and vice versa. Next, in act 412, work distributor 210 stores the formula in a database 104. Thereafter, work distributor 210 receives in act 413 (e.g. from computer 101), a request for a specific amount of dollars to be converted into points. Then, in act 414, work distributor 210 responds by retrieving the formula from the database 104, and then applies the specific amount as input to the formula to obtain points as output thereof. Then, in act 415, work distributor 210 transmits the points to the computer from which the request was received, e.g. computer 101.

In some embodiments, instead of organization head 102 distributing budget points to project managers 111A, 111B, organization head 102 distributes budget points to employees that are his/her direct reports in an hierarchical chart of the organization, e.g. VPs who may then distribute the budget points to their own direct reports, e.g. directors. In such embodiments, project managers 111A, 111B submit requests for budget points to their superiors in the hierarchical chart of the organization, as follows. Specifically, work distributor 210 of server 200 is programmed as illustrated in FIG. 4B to receive a request identifying a number of budget points (“requested budget points”) from a computer of a person (“requester”) that has work to be done, e.g. computer 110A of the project manager 111A. Then, in act 422, work distributor 210 responds by looking up a database 104 to identify e.g. in the hierarchical chart of the organization (also called “org chart”), a superior of the requester who currently has a number budget points that exceed the requested budget points (identified in the request). Next, in act 423, work distributor 210 transmits a request to a computer operated by the identified superior (e.g. a director or VP). Subsequently, in act 424, work distributor 210 receives budget points from the identified superior's computer. In response to receipt of the budget points, in an act 425, work distributor 210 transmits the budget points to a computer from which the request was received, e.g. computer 110A of the project manager 111A. Then, in an act 426, work distributor 210 reduces the budget points currently assigned to the identified superior, by the budget points transmitted in act 425 e.g. to computer 110A of the project manager 111A.

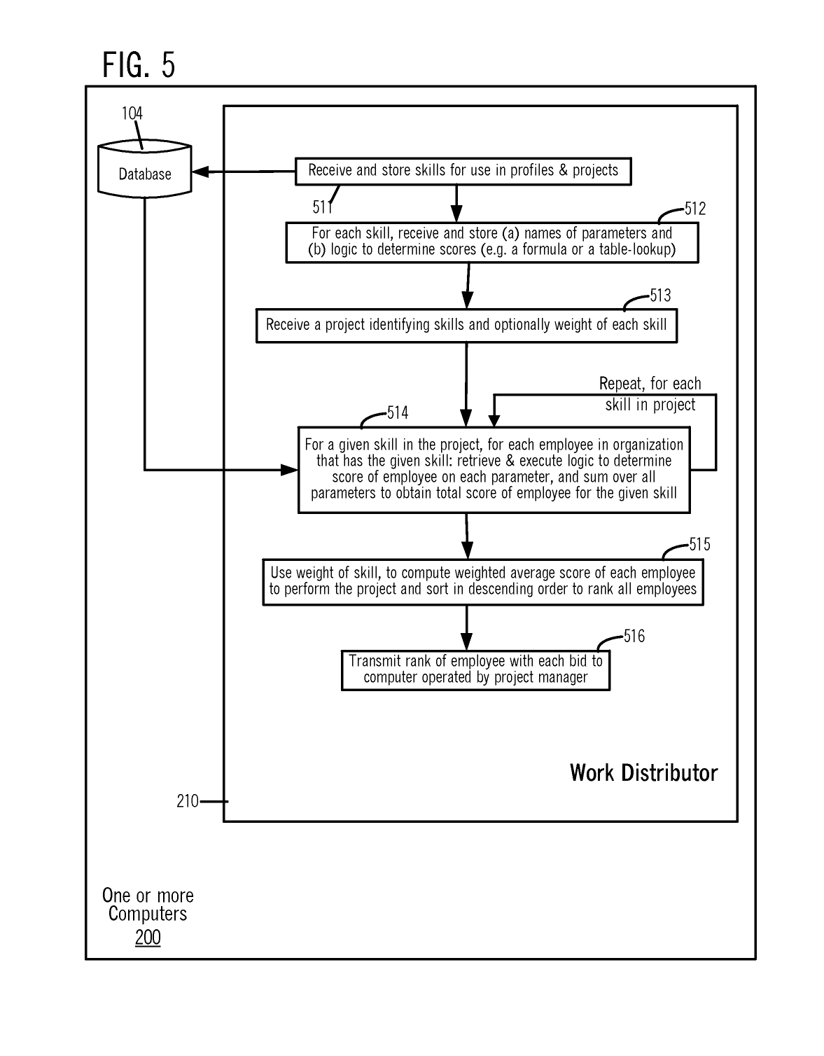

Work distributor 210 of server 200 is programmed in some embodiments to compute a rank of an employee for a specific project, based on depth of competence of the employee in one or more skills necessary to perform the specific project, as illustrated in FIG. 5. Specifically, in an act 511, work distributor 210 receives and stores in a database 104, skills K1 . . . KI . . . KZ that are to be used in profiles of employees, and in projects submitted by project managers. Examples of skills K1-KZ that are received in act 511 are: Java, C++, SQL, Oracle RDBMS, English. Thereafter, in an act 512, for each skill identified in act 511, work distributor 210 receives and stores (a) names of parameters P1 . . . Px . . . Pn, and (b) logic to compute a sub-score to be used in preparing a score for a specific skill For example, some embodiments sum up sub-scores s1 . . . sx . . . sn across all parameters P1-Pn, to obtain a skill-level score SI, wherein SI=s1 . . . +sx . . . +sn. Skill-level scores S1 . . . SI . . . SZ on corresponding skills K1 . . . KI . . . KZ identified in a project are combined (e.g. as a weighted average, using weights W1 . . . WI . . . WZ) to obtain a total score T of the employee for a given project (as T=S1W1 . . . + . . . +SIWI . . . . + . . . +SZWZ). The total score of each employee bidding on the given project is then used to rank employees in descending order, for the given project.

Examples of names of parameters P1-Pn are: (1) Certification, (2) Education, (3) Contest, (4) Projects, (5) Experience, (6) Management Rating, (7) Job Title, (8) Awards, (9) University, (10) Books & Papers, (11) Points earned by exchanging Work Product, as identified in a skill-by-skill distribution 128A, (12) Points earned by completing Projects, also identified in a skill-by-skill distribution 128A, and (13) location of the employee and the project manager close to one another, e.g. in the same city (“geo-location”). One example of logic to compute a sub-score uses if-then conditions, based on the level of a qualification of the employee in the specific skill, as per the named parameter, whereas another example of such logic uses one or more formulas and/or look up tables.

For example, specific to the parameter named “Education”, a logic to determine sub-score based on if-then conditions assigns a sub-score of 15 for a PhD degree, a sub-score of 10 for MS degree, and a sub-score of 5 for BS degree, when the just-described degree includes a course identifying the specific skill Thus, when the specific skill is Java, an employee that has taken a Java course leading to an MS degree receives a sub-score of 10 based on the Education parameter. The just-described logic may optionally identify a formula to use in computing the sub-score. In some embodiments of the example, the formula requires an if-then assigned sub-score (“raw sub-score”) to be divided by a tier-rating of a university at which the course identifying the specific skill is taken by the employee. Hence, when the Java course is taken at a second tier university, the sub-score is 10/2 wherein 10 is a raw sub-score for the MS degree as described above, and 2 is a tier-rating of the university (e.g. San Jose State University).

In another example, for a parameter named “Contest”, a logic to determine a sub-score which is received in act 512 assigns a sub-score of 10 if the employee is a winner in a national contest, and a sub-score of 6 if the employee is a winner in a state contest, and a sub-score of 2 if the employee is a winner in a local contest. In this manner, a different logic is received, via user input, in act 512, for each named parameter. The received logic may use sub-scores that are normalized relative to one another, e.g. a common upper limit score of 10 may be used for each parameter in some embodiments (“normalized embodiments”), whereas other embodiments of such logic do not normalize sub-scores.

Subsequently, in an act 513 which is similar or identical to act 212 described above, work distributor 210 receives a project including skills identified therein, and optionally receives a weight for each skill In some embodiments, no weight is received in act 513 and instead the weight is predetermined as a fixed percentage, e.g. 75% weight allocated to a skill (e.g. English) identified as being primary, and 25% weight allocated to another skill (e.g. Java) identified as being secondary, both skills required in the project (e.g. see FIG. 6A). Next, work distributor 210 repeatedly performs an act 514 for each skill in the project. In act 514, for a given skill in the project, for each employee in the organization that has the given skill, work distributor 210 retrieves and executes the logic to determine the sub-score of the employee on each parameter, and then sums up the sub-scores over all the parameters to obtain a score of the employee for the given skill (also called “skill-level score”). Then, in an act 515, work distributor 210 uses a weight of each skill in a project to compute a weighted average to obtain a total score of each employee for the project, and then sorts employees by descending order of their total scores, to obtain a ranked list of employees for the project. The positions of employees who are bidding on a specific project are identified from this ranked list to obtain ranks, and ranks are transmitted with the bids, in an act 516, to computer 110A for display to the project manager 111A, e.g. as illustrated in FIG. 6D.

In the example of FIG. 6D, the first row shows that an employee named “John Doe” is ranked 5 in the organization, among all employees who are skilled in English and Java. Similarly, the second row shows that an employee named “Tim Wilson” is ranked 9 in the organization. In the just-described example, other employees in the organization who are skilled in English and Java, and have the ranks 1-4 and the ranks 6-8 are not participating in any bids for this project (e.g. because they were not approved to bid, or because they are too busy with normal work or on vacation), and hence not shown in FIG. 6D.

Database 104 of some embodiments is implemented as a relational database which is accessible by executing software of a relational database management system (RDBMS), such as Oracle 11gR2 available from Oracle Corporation of Redwood Shores, California. In some embodiments, computer(s) 101, 110A, 120A . . . 120I . . . 120N, 130A, 130B used by employee(s) in an organization are mobile devices, such as smartphones, and/or other electronic devices that can receive user input and provide a display, such as a watch.

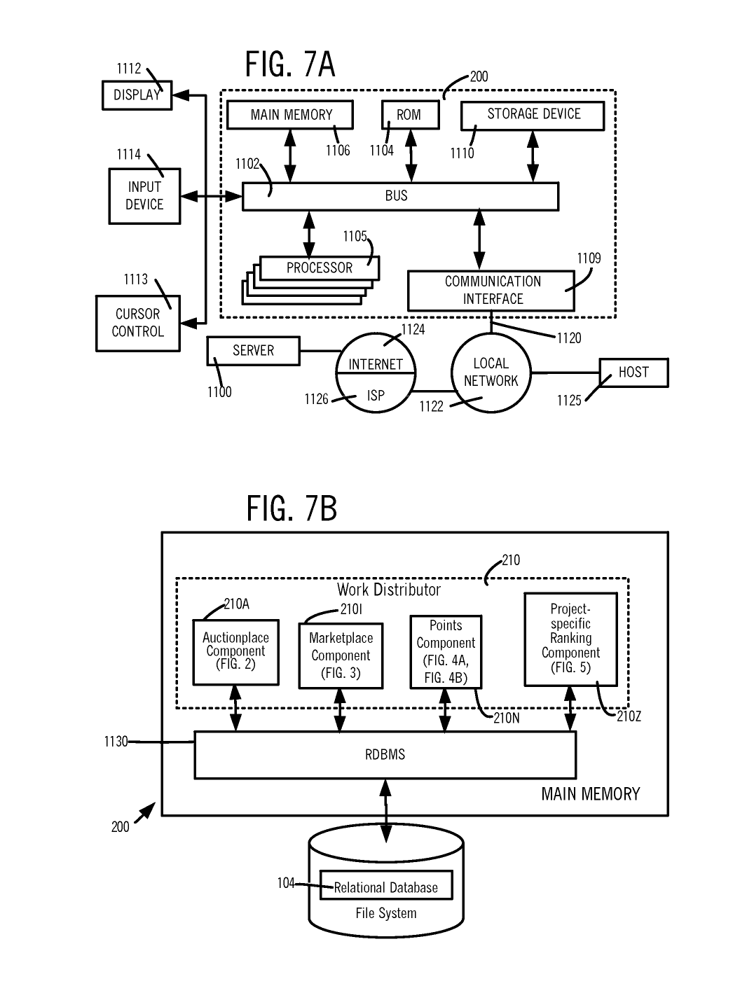

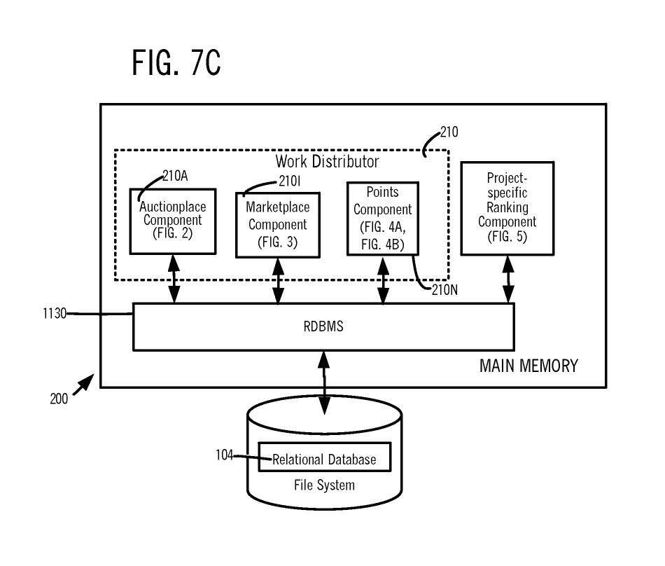

Moreover, the act(s) illustrated in FIGS. 2, 3, 4A, 4B, and 5 may be used to program one or more computer(s) 200 each of which may be implemented as illustrated in FIG. 7A and discussed below. Thus, depending on the embodiment, computer(s) 101, 110A, 120A . . . 120I . . . 120N, 130A, 130B used by employee(s) in an organization and/or computer(s) 200 used as a server may be programmed to perform one or more or all of acts illustrated in FIGS. 2, 3, 4A, 4B, and 5 in whole or in part, and in any combination with one or more hardware components described in reference to computer(s) 200 below.

In some embodiments, computer(s) 200 includes a bus 1102 (FIG. 7A) or other communication mechanism for communicating information, and one or more processor(s) 1105 coupled with bus 1102 for processing information. Computer(s) 200 uses (as the above-described memory) a main memory 1106, such as a random access memory (RAM) or other dynamic storage device, coupled to bus 1102 for storing information and instructions (e.g. to perform act(s) of FIGS. 2, 3, 4A, 4B, and 5) to be executed by processor(s) 1105.

Main memory 1106 (FIG. 7A) also may be used for storing temporary variables or other intermediate information during execution of instructions (e.g. in components 201A . . . 210I . . . 210N . . . 210Z illustrated in FIGS. 7B and 7C) by processor 1105. Computer(s) 200 further includes a read only memory (ROM) 1104 or other static storage device coupled to bus 1102 for storing static information and instructions for processor 1105, such as software in the form of a browser. A storage device 1110, such as a magnetic disk or optical disk, is provided and coupled to bus 1102 for storing information and instructions.

Computer(s) 200 (FIG. 7A) may be coupled via bus 1102 to a display device or video monitor 1112 such as a cathode ray tube (CRT) or a liquid crystal display (LCD), for displaying information (e.g. via a browser) to a computer user (e.g. user 111) on the display 1112. An input device 1114, including alphanumeric and other keys (e.g. of a keyboard), is coupled to bus 1102 for communicating information (such as user input, e.g. from any user 111) to processor 1105. Another type of user input device is cursor control 1113, such as a mouse (described above), a trackball, or cursor direction keys for communicating information and command selections to processor 1105 and for controlling cursor movement on display 1112. This input device typically has two degrees of freedom in two axes, a first axis (e.g., x) and a second axis (e.g., y), that allows the device to specify positions in a plane. In addition to display device 1112 on which output (FIGS. 6A-6E) may be displayed, computer(s) 200 may include a speaker (not shown) as another output device for use by processor 1105 in interacting with any user(s) (such as employees 121A . . . 121I . . . 121N).

As described elsewhere herein, execution of work distributor 210 (FIGS. 2, 3, 4A, 4B, and 5) in computer(s) 200 (FIG. 7A) may be implemented by one or more processor(s) 1105 executing one or more sequences of one or more instructions that are contained in main memory 1106. Such instructions may be read into main memory 1106 from another non-transitory computer-readable storage medium, such as storage device 1110. Execution of the sequences of instructions contained in main memory 1106 causes processor 1105 to create, store and update points, project-specific ranking and/or approval to bid as illustrated in FIGS. 2, 3, 4A, 4B, and 5 and/or to display screens as illustrated in FIGS. 6A-6E. In alternative embodiments, hard-wired circuitry may be used in place of or in combination with software instructions to perform act(s) illustrated in FIGS. 2, 3, 4A, 4B, and 5.

The term “non-transitory computer-readable storage media” as used herein refers to any non-transitory storage media that participate in providing instructions to processor 1105 for execution. One or more such non-transitory storage media may take many forms, including but not limited to (1) non-volatile storage media, and (2) volatile storage media. Common forms of non-volatile storage media include, for example, a floppy disk, a flexible disk, hard disk, optical disk, magnetic disk, magnetic tape, or any other magnetic medium, a CD-ROM, any other optical medium, punch cards, paper tape, any other physical medium with patterns of holes, a PROM, and EPROM, a FLASH-EPROM, any other memory chip or cartridge that can be used as storage device 1110, to store program code in the form of instructions and/or data structures and that can be accessed by computer(s) 200. Volatile storage media includes dynamic memory, such as main memory 1106 which may be implemented in the form of a random access memory or RAM.

Instructions to processor 1105 can be provided by a transmission link or by a non-transitory storage medium from which a computer can read information, such as data and/or code. Specifically, various forms of transmission link and/or non-transitory storage medium may be involved in providing one or more sequences of one or more instructions to processor 1105 for execution. For example, the instructions may initially be comprised in a non-transitory storage device, such as a magnetic disk, of a remote computer. The remote computer can load the instructions into its dynamic memory (RAM) and send the instructions over a telephone line using a modem.

A modem local to computer(s) 200 (FIG. 7A) can receive information about a change to a collaboration object on the telephone line and use an infra-red transmitter to transmit the information in an infra-red signal. An infra-red detector can receive the information carried in the infra-red signal and appropriate circuitry can place the information on bus 1102. Bus 1102 carries the information to main memory 1106, from which processor 1105 retrieves and executes the instructions. The instructions received by main memory 1106 may optionally be stored on storage device 1110 either before or after execution by processor 1105.

Computer(s) 200 (FIG. 7A) also includes a communication interface 1115 coupled to bus 1102. Communication interface 1115 provides a two-way data communication coupling to a network link 1120 that is connected to a local network 1122. Local network 1122 may interconnect multiple computers (as described above). For example, communication interface 1115 may be an integrated services digital network (ISDN) card or a modem to provide a data communication connection to a corresponding type of telephone line. As another example, communication interface 1115 may be a local area network (LAN) card to provide a data communication connection to a compatible LAN. Wireless links may also be implemented. In any such implementation, communication interface 1115 sends and receives electrical, electromagnetic or optical signals that carry digital data streams representing various types of information.

Network link 1120 (FIG. 7A) typically provides data communication through one or more networks to other data devices. For example, network link 1120 may provide a connection through local network 1122 to a host computer 1125 or to data equipment operated by an Internet Service Provider (ISP) 1126. ISP 1126 in turn provides data communication services through the world wide packet data communication network 1124 now commonly referred to as the “Internet”. Local network 1122 and network 1124 both use electrical, electromagnetic or optical signals that carry digital data streams. The signals through the various networks and the signals on network link 1120 and through communication interface 1115, which carry the digital data to and from computer(s) 200, are exemplary forms of carrier waves transporting the information.

Computer(s) 200 (FIG. 7A) can send messages and receive data, including program code, through the network(s), network link 1120 and communication interface 1115. In the Internet example, a server 1100 might transmit information retrieved from RDBMS database through Internet 1124, ISP 1126, local network 1122 and communication interface 1115. The instructions for performing the operations of FIGS. 2, 3, 4A, 4B, and 5 may be executed by processor 1105 as they are received, and/or stored in storage device 1110, or other non-volatile storage for later execution. In this manner, computer(s) 200 may additionally or alternatively obtain instructions and any related data.

FIG. 7A is a very low-level representation of many hardware components of one or more of computer(s) 200 described above in reference to FIGS. 2, 3, 4A, 4B, and 5. Several embodiments have one or more additional software components 210A . . . 210I . . . 210N . . . 210Z in main memory 1106 as shown in FIG.7B. In addition to main memory 1106, computer(s) 200 may include one or more other types of memory such as flash memory (or SD card) and/or a hard disk and/or an optical disk (also called “secondary memory”) to store data and/or software for loading into memory 1106 (also called “main memory”) and/or for use by processor(s) 1105. In some embodiments, computer(s) 200 of FIG. 7A implements a relational database management system 1130 (FIG. 7B) to manage data in one or more tables of a relational database 120 of the type illustrated in FIG. 7B. Such a relational database management system may manage a distributed database system that includes multiple databases, each table being stored on different storage mechanisms.

In some embodiments, the multiple databases are made to appear as a single database. In such embodiments, processor 1105 can access and modify the data in a relational database 120 via RDBMS 1130 (FIG. 7B) that accepts queries from various software components 210A . . . 210I . . . 210N . . . 210Z in conformance with a relational database language, the most common of which is the Structured Query Language (SQL). The commands are used by processor 1105 of some embodiments to store, modify and update points, project-specific ranking and/or approval to bid in the form of rows in tables in relational database 120.

Relational database management system 1130 (FIG. 7B) further includes output logic that makes the data in a database table of relational database 120 available to a user via a graphical user interface that generates a screen on a video monitor display 1112, such as the screens illustrated in FIGS. 6A-6E. In one example, the output logic of computer(s) 200 provides output 125, 126A (FIG. 1A) via a web-based user interface that depicts in a browser of another computer 110A, information related to points, project-specific ranking and/or bids that have been approved by approvers of bidding employees. Additionally and/or alternatively, screens responsive to user input via a keyboard as a command in a command-line interface of computer 110A and/or user input via a mouse and a cursor displayed on a video monitor of computer 110A may be generated by computer(s) 200.

In some embodiments of computer(s) 200, functionality in the above-described operations or acts of FIGS. 2, 3, 4A, 4B, and 5 is implemented by processor 1105 (FIG. 7A) executing software in memory 1106 of computer(s) 200, although in other embodiments such functionality is implemented in any combination of hardware circuitry and/or firmware and/or software in computer(s) 200. Depending on the embodiment, various functions of the type described herein may be implemented in software (executed by one or more processors or processor cores) or in dedicated hardware circuitry or in firmware, or in any combination thereof. Accordingly, depending on the embodiment, any one or more of the means for performing operations or acts of FIGS. 2, 3, 4A, 4B, and 5 can, but need not necessarily include, one or more microprocessors, embedded processors, controllers, application specific integrated circuits (ASICs), digital signal processors (DSPs), multi-core processors and the like, appropriately programmed with software in the form of instructions to implement one or more steps of the type described herein.

Any non-transitory computer-readable medium tangibly embodying software (also called “computer instructions”) may be used in implementing one or more acts or operations described herein and illustrated in FIGS. 2, 3, 4A, 4B, and 5. Such software may include program codes stored in memory 1106 and executed by processor 1105 (FIG. 7A). Memory 1106 may be implemented within or external to processor 1105, depending on the embodiment. When implemented in firmware and/or software, logic to perform one or more acts or operations of FIGS. 2, 3, 4A, 4B, and 5 may be stored as one or more computer instructions or code on a non-transitory computer-readable medium.

In some embodiments, one or more of computer(s) 200 may include multiple processors, each of which is programmed with software in a memory 1106 shared with each other to perform acts of the type described above to implement the individual components illustrated in FIGS. 7B and 7C. For example, a first processor 1105 in computer(s) 200 may be programmed with software in memory 1106 to implement acts 211-223 of FIG. 2 in a component 210A. A second processor 1105 in computer(s) 200 may be programmed with software in memory 1106 (FIG. 7A) to implement acts 311-316 of FIG. 3 in a component 2101. A third processor 1105 in computer(s) 200 may be programmed with software in memory 1106 to implement acts 411-415 of FIG. 4A and acts 421-426 of FIG. 4B in a component 210N. A fourth processor 1105 in computer(s) 200 may be programmed with software in memory 1106 to implement acts 511-516 of FIG. 5 in a component 210Z, which depending on the embodiment is implemented internal to work distributor 210 (as illustrated in FIG. 7B) or external to work distributor 210 (as illustrated in FIG. 7C), or partly internal and partly external as will be apparent to a skilled artisan. The just-described four processors 1105 are programmed to interoperate with one another to form work distributor 210.

Although four processors 1105 (FIG. 7A) have been just described for some embodiments to implement the respective means, in other embodiments a single processor 1105 may be used in a time shared manner to implement the just-described means of the previous paragraph. Furthermore, in still other embodiments, one processor 1105 may be used in a time-shared manner to implement one or more parts of various components. Moreover, one or more processors 1105 may be programmed to implement one or more components of work distributor 210. Furthermore, although processors 1105 have been described above for certain embodiments as being included in a single computer(s) 200, in other embodiments multiple such processors 1105 may be included in multiple computers 200, for example four computers 200 may implement the operations described above in reference to FIGS. 2, 3, 4A, 4B, and 5. Additionally, in one or more such embodiments, one or more processor(s) 1105 with a bus 1103 execute enterprise resource planning (ERP) software in computer(s) 200.

Various adaptations and modifications may be made without departing from the scope of the described embodiments. Numerous modifications and adaptations of the embodiments described herein are encompassed by the attached claims.

1. A method to improve functioning of a computer system that distributes work, the method comprising:
a set of computers preparing and transmitting to a server, a set of bids to perform work on a specific project selected from a set of projects identified in a database;
wherein each bid in the set of bids comprises an identifier of an employee having a profile in the database such that a plurality of first skills identified in the specific project match a plurality of second skills identified in the profile;
the set of computers or the server identifying by use of the database, an approver of the employee identified in said each bid;
the set of computers or the server transmitting to a first computer operated by the approver of the employee identified in said each bid, a request to respond with approval or disapproval for said employee to bid on the specific project;
for any bids in the set of bids for which an approval is received by the set of computers or the server, the server transmitting said any bids to a second computer from which the specific project is received;
the server receiving from the second computer, a decision accepting a specific bid, based on selection thereof by user input from among said any bids; and
the server transmitting to the set of computers, the decision accepting the specific bid.

2. The method of claim 1 further comprising:
the second computer receiving directly or indirectly from a third computer operated by an organizational head identified in a hierarchical chart in the database, a first number of points assignable to one or more projects; and
the second computer transmitting to the server, a second number of points assigned to the specific project, the second number of points being selected to be less than or equal to the first number of points;
each computer in the set of computers transmitting to the server, a third number of points associated with each bid, the third number of points being selected to be less than or equal to the second number of points; and
prior to receipt of the decision accepting the specific bid, the server transmitting to the second computer, one or more third number of points in association with said one or more bids.

3. The method of claim 2 further comprising:
the server receiving from the second computer, an indication of acceptance of work product of the specific project;
the server transmitting a fourth number of points to a computer operated by the employee identified in the specific bid and a fifth number of points to the first computer operated by the approver of the employee;
wherein a total of the fourth numbers of points and the fifth numbers of points is equal to the third number of points associated with the specific bid; and
wherein each fifth number is a fixed percentage of the fourth number.

4. The method of claim 2 further comprising:
the server receiving from computers operated by employees, a plurality of work products, descriptions of the work products, and numbers of points associated thereto;
the server transmitting to a plurality of computers, the descriptions and the numbers of points associated thereto;
the server transmitting to a specific computer in the plurality of computers, a work product on request thereof and the server transmitting the number of points associated with the work product to a computer operated by the employee from which the work product is received.

5. The method of claim 2 further comprising:
prior to receipt of the decision accepting the specific bid, the server transmitting to the second computer, one or more ranks in association with said one or more bids;
wherein each rank is obtained by sorting in descending order, total scores of employees having the plurality of second skills matching the plurality of first skills identified in the specific project;
wherein the total score of each employee is computed based on a plurality of skill-level scores of said each employee corresponding to the plurality of second skills;
wherein each skill-level score of said each employee for a second skill is computed based on a plurality of sub-scores on a plurality of parameters associated with the second skill; and
wherein each sub-score on a parameter associated with the second skill is obtained by executing a logic associated with the parameter.

6. The method of claim 1 wherein:
each computer in the set of computers is a mobile device.

7. One or more non-transitory computer-readable storage media comprising a plurality of instructions that when executed cause one or more processors to perform a method, the method comprising:
a set of computers preparing and transmitting to a server, a set of bids to perform work on a specific project selected from a set of projects identified in a database;
wherein each bid in the set of bids comprises an identifier of an employee having a profile in the database such that a plurality of first skills identified in the specific project match a plurality of second skills identified in the profile;
the set of computers or the server identifying by use of the database, an approver of the employee identified in said each bid;
the set of computers or the server transmitting to a first computer operated by the approver of the employee identified in said each bid, a request to respond with approval or disapproval for said employee to bid on the specific project;
for any bids in the set of bids for which an approval is received by the set of computers or the server, the server transmitting said any bids to a second computer from which the specific project is received; and
the server receiving from the second computer, a decision accepting a specific bid, based on selection thereof by user input from among said any bids; and
the server transmitting to the set of computers, the decision accepting the specific bid.

8. The one or more non-transitory computer-readable storage media of claim 7 wherein the method further comprises:
the second computer receiving directly or indirectly from a third computer operated by an organizational head identified in a hierarchical chart in the database, a first number of points assignable to one or more projects; and
the second computer transmitting to the server, a second number of points assigned to the specific project, the second number of points being selected to be less than or equal to the first number of points;
each computer in the set of computers transmitting to the server, a third number of points associated with each bid, the third number of points being selected to be less than or equal to the second number of points; and
prior to receipt of the decision accepting the specific bid, the server transmitting to the second computer, one or more third number of points in association with said one or more bids.

9. The one or more non-transitory computer-readable storage media of claim 8 wherein the method further comprises:
the server receiving from the second computer, an indication of acceptance of work product of the specific project;
the server transmitting a fourth number of points to a computer operated by the employee identified in the specific bid and a fifth number of points to the first computer operated by the approver of the employee;
wherein a total of the fourth numbers of points and the fifth numbers of points is equal to the third number of points associated with the specific bid; and
wherein each fifth number is a fixed percentage of the fourth number.

10. The one or more non-transitory computer-readable storage media of claim 8 wherein the method further comprises:
the server receiving from computers operated by employees, a plurality of work products, descriptions of the work products, and numbers of points associated thereto;
the server transmitting to a plurality of computers, the descriptions and the numbers of points associated thereto;
the server transmitting to a specific computer in the plurality of computers, a work product on request thereof and the server transmitting the number of points associated with the work product to a computer operated by the employee from which the work product is received.

11. The one or more non-transitory computer-readable storage media of claim 8 wherein the method further comprises:
prior to receipt of the decision accepting the specific bid, the server transmitting to the second computer, one or more ranks in association with said one or more bids;
wherein each rank is obtained by sorting in descending order, total scores of employees having the plurality of second skills matching the plurality of first skills identified in the specific project;
wherein the total score of each employee is computed based on a plurality of skill-level scores of said each employee corresponding to the plurality of second skills;
wherein each skill-level score of said each employee for a second skill is computed based on a plurality of sub-scores on a plurality of parameters associated with the second skill; and
wherein each sub-score on a parameter associated with the second skill is obtained by executing a logic associated with the parameter.

12. A system comprising one or more processors coupled to one or more non-transitory computer-readable storage media, wherein the one or more non-transitory computer-readable storage media comprise a plurality of instructions that when executed cause the one or more processors to perform a method, the system being configured to:
prepare and transmit a set of bids to perform work on a specific project selected from a set of projects identified in a database;
wherein each bid in the set of bids comprises an identifier of an employee having a profile in the database such that a plurality of first skills identified in the specific project match a plurality of second skills identified in the profile;
identify by use of the database, an approver of the employee identified in said each bid;
transmit to a first computer operated by the approver of the employee identified in said each bid, a request to respond with approval or disapproval for said employee to bid on the specific project;
for any bids in the set of bids for which an approval is received, transmit said any bids to a second computer from which the specific project is received;
receive from the second computer, a decision accepting a specific bid, based on selection thereof by user input from among said any bids; and
transmit the decision accepting the specific bid.
